(19) United States
(12) Patent Application Publication
(10) Pub. No.: US 2009/0094646 A1
(43) Pub. Date: Apr. 9, 2009

(54) METHOD AND SYSTEM FOR CONTENT MAPPING

(75) Inventors: Edward Walter, Boerne, TX (US); Larry B. Pearson, San Antonio, TX (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/867,583

(22) Filed: Oct. 4, 2007

(51) Int. Cl. H04N 7/10

(52) U.S. Cl. 725/48

(57) ABSTRACT

Methods and systems for content mapping are described. Information regarding available content may be received from a plurality of content sources. A plurality of available content selections may be provided for presentation. The plurality of available content selections may be in accordance with the received information. A selection of content may be received from a user. The selection may be from the plurality of available content selections. The content may be associated with a selected content source from the plurality of content sources. The selected content source may be of a source type. A channel may be mapped to the content in accordance with the source type to create a mapped channel. The mapped channel may be added to an electronic program guide.

### FIELD

This application relates to a method and system for content processing, and more specifically to methods and systems for content mapping.

### BACKGROUND

Electronic program guides present available content selections of a particular content source for selection. When a content selection is made, the content is provided for presentation to a user.

### BRIEF DESCRIPTION OF DRAWINGS

Embodiments are illustrated by way of example and not limitation in the figures of the accompanying drawings, in which like reference characters indicate similar elements and in which:

FIG. 1 is a block diagram of an example content system according to an example embodiment;

FIG. 2 is a block diagram of an example guide subsystem that may be deployed in the content system of FIG. 1 according to an example embodiment;

FIGS. 3 and 4 are flowcharts illustrating a method for electronic program guide distribution in accordance with an example embodiment;

FIG. 5 is a flowchart illustrating a method for content distribution in accordance with an example embodiment;

FIGS. 6 and 7 are flowcharts illustrating a method for determining a user association in accordance with an example embodiment;

FIG. 8 is a flowchart illustrating a method for content distribution in accordance with an example embodiment;

FIGS. 9-11 are block diagrams of example user interfaces for an electronic programming guide in accordance with an example embodiment;

FIG. 12 is a block diagram of an IPTV system in which the content system of FIG. 1 may be deployed in accordance with an example embodiment; and

FIG. 13 illustrates a diagrammatic representation of a machine in the example form of a computer system within which a set of instructions for causing the machine to perform any one or more of the methodologies discussed herein may be executed.

### DETAILED DESCRIPTION

Example methods and systems for content mapping are described. In the following description, for purposes of explanation, numerous specific details are set forth in order to provide a thorough understanding of example embodiments. It will be evident, however, to one skilled in the art that the present invention may be practiced without these specific details.

In an example embodiment, information regarding available content may be received from a plurality of content sources. A plurality of available content selections may be provided for presentation. The plurality of available content selections may be in accordance with the received information. A selection of content may be received from a user. The selection may be from the plurality of available content selections. The content may be associated with a selected content source from the plurality of content sources. The selected content source may be of a source type. A channel may be mapped to the content in accordance with the source type to create a mapped channel. The mapped channel may be added to an electronic program guide.

In an example embodiment, information regarding available content may be received from a plurality of content sources. A selection of content from the plurality of available content selections may be processed in accordance with a profile. The content may be associated with a selected content source from the plurality of content sources. The selected content source may be of a source type. A channel may be mapped to the content in accordance with the source type to create a mapped channel. The mapped channel may be added to an electronic program guide.

In an example embodiment, an electronic program guide may be provided for presentation. The electronic program guide may include a plurality of available channels. A channel selection of one of the available channels from the plurality of available channels may be received. A mapping associated with the channel selection may be accessed. The mapping may include a source identifier and a content identifier. Content may be received in accordance with the content identifier from a content source associated with the source identifier. The received content may be provided for presentation through the available channel.

In an example embodiment, an electronic program guide may be provided for presentation. The electronic program guide may include a plurality of content selections. A selected content selection may be received from the plurality of content selections. A mapping associated with the selected content selection may be accessed. The mapping may include a source identifier and a content identifier. The selected content selection may be received in accordance with the content identifier from a content source associated with the source identifier. The received content may be provided for presentation through a channel associated with the content selection.

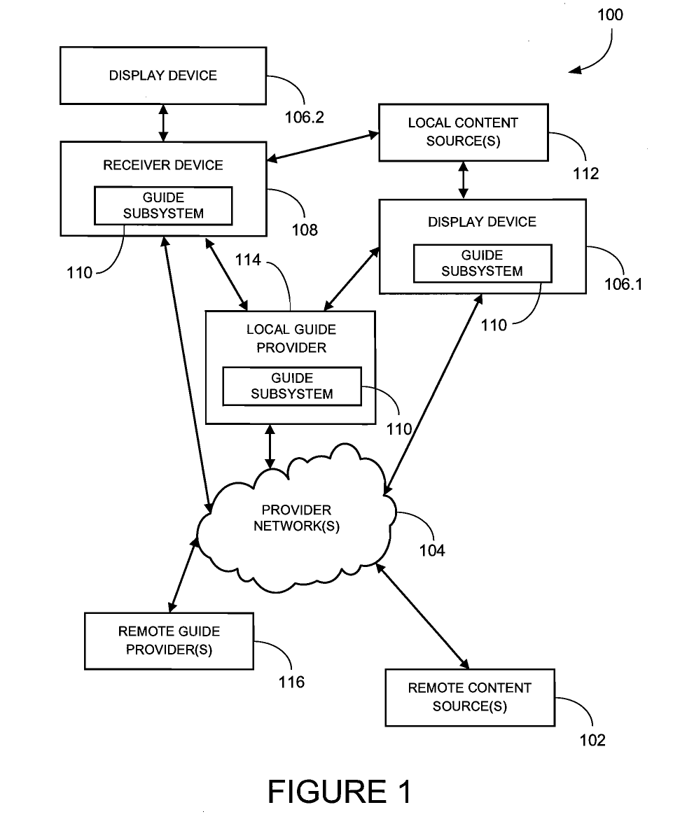

FIG. 1 illustrates an example content system 100. Content in the form of a video signal may be provided from one or more local content sources 112 and/or over a provider network 104 from one or more remote content sources 102 to a display device 106.1, and/or a receiver device 108 for presentation on the display device 106.1, and/or a display device 106.2.

The video signal may be a sequence of images and one or more associated audio tracks. The video signal may be a high quality video stream (e.g., MPEG-4) that is transcoded (e.g., into H.264) for distribution to the display device 106.1 and/or the receiver device 108. The video signal may include standard definition (SD) or high definition (HD) video signals in NTSC (National Television System Committee), PAL (Phase Alternation Line), SECAM (Systeme Electronique Couleur Avec Memoire), sequence of bitmaps or other signal formats that transport a sequence of images. The form of the video signal may be modified to enable implementations of various formats and resolutions. The video signal may provide a variety of content types including, without limitation, television programs, music, movies, and commercials.

The remote content source 102 may be a television station, a broadcast network, a server, or the like. The local content source 112 may be another receiver device (e.g., a set-top box from a same provider or a different provider), a stand-alone DVD player, a DVD jukebox player, a VCR player, a CD player, a stereo receiver, and the like. The content provided by the content sources 102, 112 may include video-on-demand (VOD) content, broadcast content, or stored content. However, other types of content may also be used.

The content source may be of a specific source type. The source type may include a cable provider, an access device, a DVD, or an Internet source (e.g., including clips and IPTV).

The provider network 104 may be a television distribution network, Global System for Mobile Communications (GSM) network, an Internet Protocol (IP) network, a Wireless Application Protocol (WAP) network, and/or a WiFi network. Other networks may also be used.

The display device 106.1, 106.2, may be a television monitor, a mobile telephone, a portable gaming device, a personal digital assistant (PDA), a computer monitor, and the like. Other types of display devices may also be used.

The receiver device 108 and/or the display device 106.1 may include a guide subsystem 110 to provide an electronic program guide that may be used for content selection. The electronic program guide may include a number of available channels including one or more preexisting channels and/or one or more mapped channels and a number of content selections available under the channels or otherwise available. The mapped channels may be used to provide content available for selection from multiple content sources 102, 112.

The mapping used by an electronic program guide may define a path and/or relationship to content (e.g., a content program and/or a channel). Mapping enables selection of content and in the electronic program guide that has not been previously specified by, for example, a remote guide provider 116 and/or the remote content sources 102. The mapping of the channel enables selection of the channel in the electronic program guide, while the mapping of specific content enables selection of a content program in electronic program guide. For example, multiple programs from multiple content sources may be mapped into a single channel, and one or more channels from a first content source and one or more channels from a second source may be mapped into a single content guide. The electronic program guide may be unified in that it includes mapped channels from multiple content sources in a single electronic program guide.

In an example embodiment, providing a unified electronic program guide with mapped channels from multiple content sources 102, 112 may enable a user to more quickly and easily view content selections and select content from the multiple content sources 102, 112.

A channel number and a listing of content available may be associated with an available channel in the electronic program guide. An example embodiment of the guide subsystem 110 is described in greater detail below.

Information used to create an electronic program guide with mapped channels may be received from the remote content sources 102, one or more remote guide providers 116, and/or the local content sources 112. The remote guide providers 116 may be a source of guide information without providing content.

A local guide provider 114 may be used to create electronic program guides with one or more mapped channels for distribution to the display device 106.1, and/or the receiver device 108.

Examples of the receiver device 108 include a set-top box (STB), a receiver card, a mobile telephone, a PDA, and a computing system; however other devices may also be used. A remote control may control the display device 106.1, 106.2, and/or the receiver device 108.

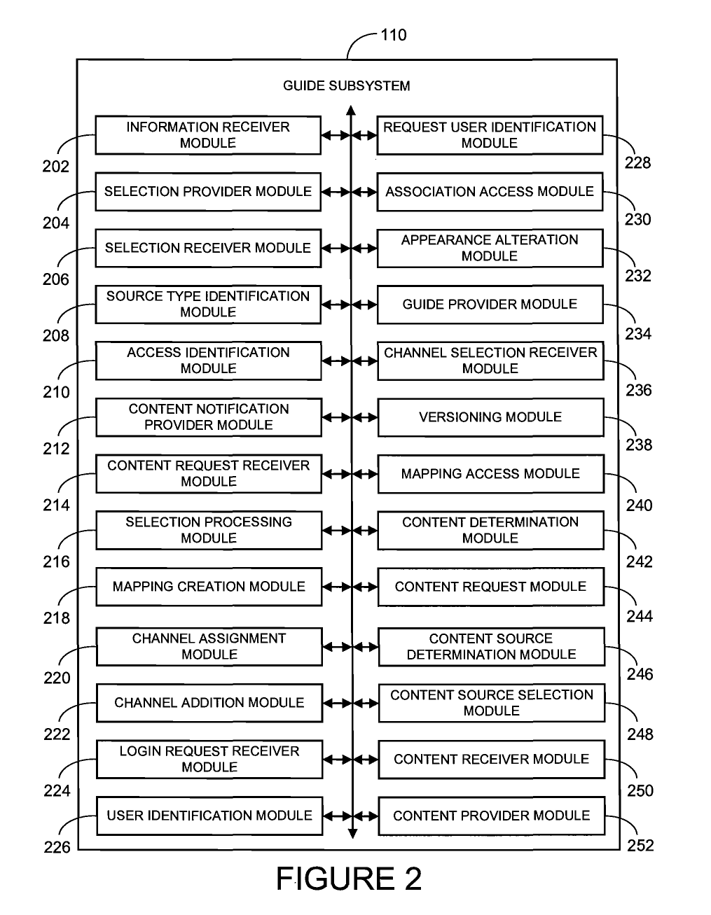

FIG. 2 illustrates an example guide subsystem 110 that may be deployed in the content system 100 (see FIG. 1) and/or another system.

The guide subsystem 110 may include an information receiver module 202, a selection provider module 204, a selection receiver module 206, a source type identification module 208, an access identification module 210, a content notification provider module 212, a content request receiver module 214, a selection processing module 216, a mapping creation module 218, a channel assignment module 220, a channel addition module 222, a login request receiver module 224, a user identification module 226, a request user identification module 228, an association access module 230, an appearance alternation module 232, a guide subsystem module 234, a channel selection receiver module 236, a versioning module 238, a mapping access module 240, a content determination module 242, a content request module 244, a content source selection module 248, a content receiver module 250, and/or a content provider module 252. Other modules may also be used.

The information receiver module 202 receives information regarding available content from the local content sources 112 and/or the remote content sources 102. The selection provider module 204 provides available content selections for presentation. The available content selections may be in accordance with the received information from the information receiver module 202.

The selection receiver module 206 receives a selection of content (e.g., a selected content selection) from a user. The selection may be from the available content selections from the local content sources 112 and/or the remote content sources 102. The source type identification module 208 identifies the source type of the selected content source associated with the selection received by the selection receiver module 206.

The access identification module 210 identifies an access identifier for the selected content source. The access identifier may an IP address, an IPTV server address, a frequency of an original broadcast channel, a URL, or the like. The content notification provider module 212 provides a content notification of the content according to a selection profile. The content request receiver module 214 receives a content request in response to a content notification.

The selection processing module 216 processes a selection of content from the available content selections in accordance with a selection profile and/or a content request. The selection profile may be associated with a particular user, a particular content genre, a particular content source, or the like.

The mapping creation module 218 maps a channel to the selected content in accordance with the source type and/or the access identifier to create a mapped channel. The channel assignment module 220 assigns a unique channel identifier to the mapped channel. A value of the unique channel identifier may be assigned based on a priority criterion (e.g., most watched content first).

The channel addition module 222 adds the mapped channel to an electronic program guide. The login request receiver module 224 receives a login request for the user.

The user identification module 226 determines an identity of one or more users (e.g., in an area near where an electronic program guide is to be provided). The identify of the users may be determined by a mobile telephone, a portable gaming device, a remote control, or another device associated with the user. The identity may also be determined in other ways beyond the user of a user device.

The request user identification module 228 identifies a requesting user from among multiple users based on a selection criterion. The selection criterion may be signal strength of a mobile device or other device, a first user to have made a request, a last user to have made a request, a user most likely to select a particular content type, or the like.

The association access module 230 accesses a user association of the user with the electronic program guide. The appearance alternation module 232 alters appearance of an available channel in accordance with a user profile. The altering of the appearance may include channel highlighting, channel hiding, or the like.

The guide subsystem module 234 provides the electronic program guide (e.g., an original electronic program guide and/or an alerted program guide) for presentation to the user (e.g., on the display device 106.1, 106.2) and/or an access device (e.g., the display device 106.1 or the receiver device 108). The electronic program guide may be presented in a time-oriented manner, a name-oriented manner, or a category-oriented manner. The electronic program guide may be provided for presentation based on a login request and/or a user association. For example, the login request or user association may be used to identify a particular user and provide the electronic program guide for the particular user.

The channel selection receiver module 236 receives a channel selection of an available channel from the available channels. The versioning module 238 provides notification regarding available versions of the content and/or receives a request for a selected version of the content from the available versions.

The mapping access module 240 accesses a mapping associated with the channel selection. The mapping may include a source identifier and a content identifier. The mapping may be accessed based on the selected content selection and the selection version.

The content determination module 242 determines whether the content is available from the content source associated with the source identifier. The content request module 244 sends a content request including a content identifier to the content source associated with the source identifier.

The content source determination module 246 determines available content sources including the selected content selection. The content source selection module 248 selects the content source from the content sources 102, 112 based on a selection criterion.

The content receiver module 250 receives, from a content source (e.g., a selected content source) associated with the source identifier, content in accordance with the content identifier and/or a determination of whether the content is available.

The content provider module 252 provides the content (e.g., the selected content or the received content) through the mapped channel and/or the received content for presentation through a channel (e.g., an available channel) that may be associated with a content selection.

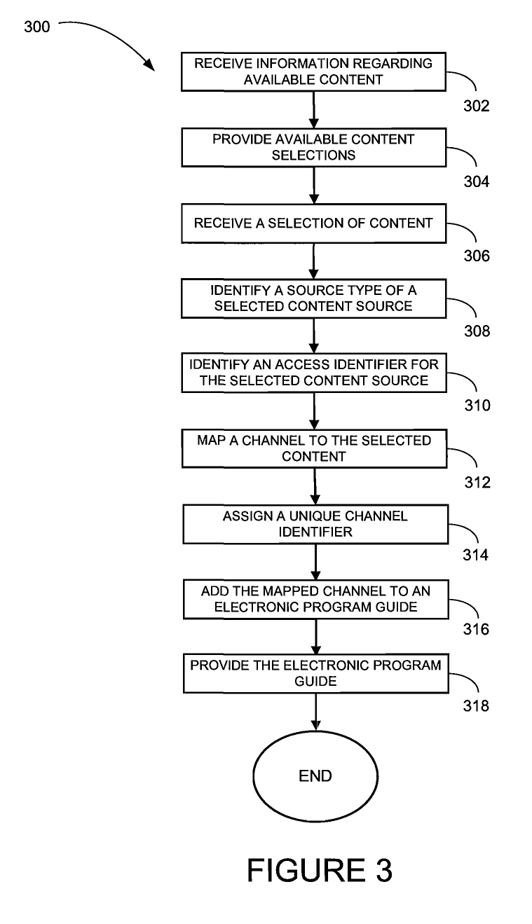

FIG. 3 illustrates a method 300 for electronic program guide distribution according to an example embodiment. The method 300 may be performed by the guide subsystem 110 (see FIG. 1) of the content system 100 or otherwise performed.

Information regarding available content is received from one or more of the content sources 102, 112 at block 302. The content provided by the content sources 102, 112 may include video-on-demand (VOD) content, broadcast content, or stored content. However, other types of content may also be used.

The received information regarding available content may include scheduling data, a content guide, and/or a contenting listing. Other types of information may also be received.

Available content selections are provided for presentation at block 304. The content selections may be in accordance with the received information.

A selection of content is received from a user at block 306. The selection may be from the available content selections. The selected content may be associated with a selected content source from the content sources 102, 112.

The source type of the selected content source associated with the selection may be identified at block 308.

An access identifier may be identified for the selected content source at block 310. The access identifier may include an IP address, an IPTV server address, a frequency, and/or a URL. Other types of access identifiers may also be used.

At block 312, a channel is mapped to the selected content in accordance with the source type to create a mapped channel. The mapping of the channel to the selection of content may be in accordance with the source type and the access identifier to create the mapped channel. The mapped channel may include a linear timeline of the selected content with a first program of the content starting at a first time, a second program of the content starting at a second time, etc.

At block 314, a unique channel identifier may be assigned to the mapped channel. A value of the unique channel identifier may be assigned based on a priority criterion (e.g., most watched content first) to enable higher demand channels appear first in the electronic program guide.

The mapped channel is added to an electronic program guide at block 316. The electronic program guide may include one or more preexisting channels. The mapped channel may include a unique channel identifier within the electronic program guide.

The electronic program guide may be provided at block 318. The electronic program guide may be for presentation to the user, to the access device (e.g., from the local guide provider 114 to the display device 106.1 and/or the receiver device 108), or otherwise provided. The electronic program guide may be provided for presentation in a time-oriented manner, a name-oriented manner, or a category-oriented manner.

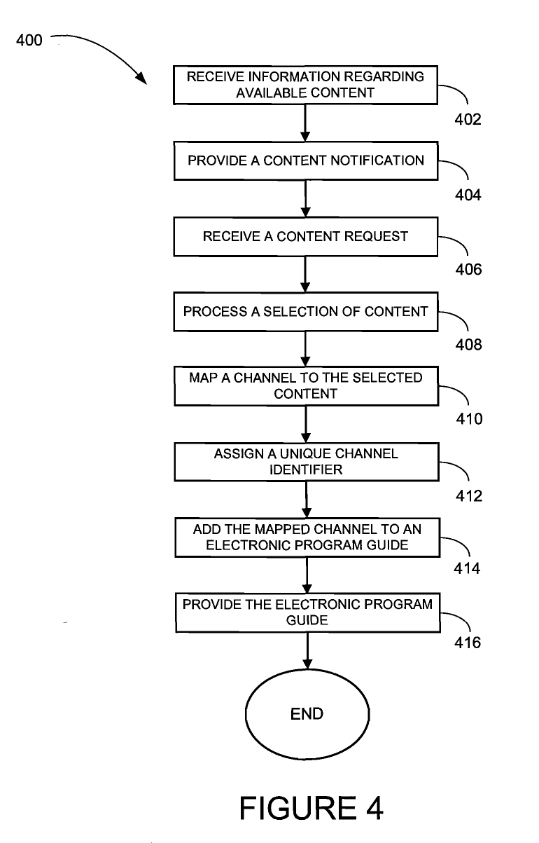

FIG. 4 illustrates a method 400 for electronic program guide distribution according to an example embodiment. The method 400 may be performed by the guide subsystem 110 (see FIG. 1) of the content system 100 or otherwise performed.

Information regarding available content from the content sources 102, 112 is received at block 402.

A content notification of the content may be provided according to a content profile at block 404. The content profile may be associated with a particular user, a particular content genre, and/or particular content source. Other types of content profiles may also be used. A content request may be received in response to the content notification at block 406.

At block 408, a selection of content from the available content selections may be processed in accordance with the content profile and/or the content request. The selected content may be associated with a selected content source from the content sources 102, 112.

A channel is mapped to the selected content in accordance with the source type to create a mapped channel at block 410.

At block 412, a unique channel identifier may be assigned to the mapped channel. A value of the unique channel identifier may be assigned based on a priority criterion (e.g., most watched content first).

The mapped channel is added to an electronic program guide at block 414. The mapped channel may include a unique channel identifier within the electronic program guide.

The electronic program guide may be provided at block 416. The electronic program guide may be for presentation to the user, to the access device, or otherwise provided. The electronic program guide may be presented in a time-oriented manner, a name-oriented manner, or a category-oriented manner.

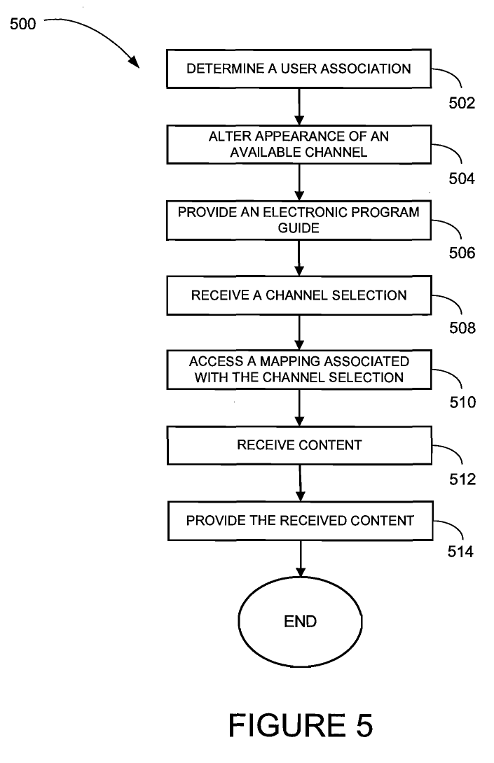

FIG. 5 illustrates a method 500 for content distribution according to an example embodiment. The method 500 may be performed by the guide subsystem 110 (see FIG. 1) of the content system 100 or otherwise performed.

At block 502, a user association may be determined to identify an electronic program guide associated with a particular user. For example, a login request may be received for the user and/or the identity of one or more users may be determined to identify the particular user

Appearance of an available channel may be altered in accordance with a user profile at block 504. The alteration of the appearance may include channel highlighting or channel hiding based on, by way of example, a preference of a user in accordance with the user profile. Other types of alterations may also be performed.

An electronic program guide is provided for presentation at block 506. The electronic program guide may be an altered programming guide or the original programming guide. The electronic program guide provided for presentation may be based on the login request and/or the determined identity of a user.

At block 508, a channel selection of an available channel from the available channels is received. A unique channel identifier may be associated with the channel selection.

A mapping associated with the channel selection is accessed at block 510. The mapping may be stored on a device with the electronic program guide or otherwise stored. The mapping may include a source identifier and a content identifier. By way of an example, the source identifier may be a television broadcast station and the content identifier may be an original channel selection.

At block 512, content is received in accordance with the content identifier from a content source associated with the source identifier.

In an example embodiment, a determination of whether the content is available from the content source associated with the source identifier may be made and/or a content request including a content identifier may be sent to the content source associated with the source identifier. The content may be received in accordance with the content identifier and the determining of whether the content is available and/or in accordance with the content request.

The received content is provided for presentation through the available channel at block 514. For example, the content may be presented on the display device 106.1, 106.2.

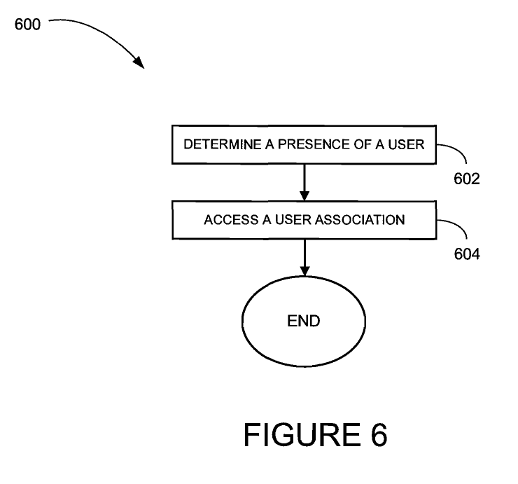

FIG. 6 illustrates a method 600 for determining a user association according to an example embodiment. The method 600 may be performed at block 502 (see FIG. 5) or otherwise performed.

An identity of a user is determined at block 602. The identity of the user may be determined by a mobile telephone associated with the user, a portable gaming device associated with the user, and/or a remote control associated with the user. The identity may also be otherwise determined.

A user association of the user with the electronic program guide is accessed at block 604. In an example embodiment, the electronic program guide may provided for the presentation based on the user association (e.g., as performed at block 506).

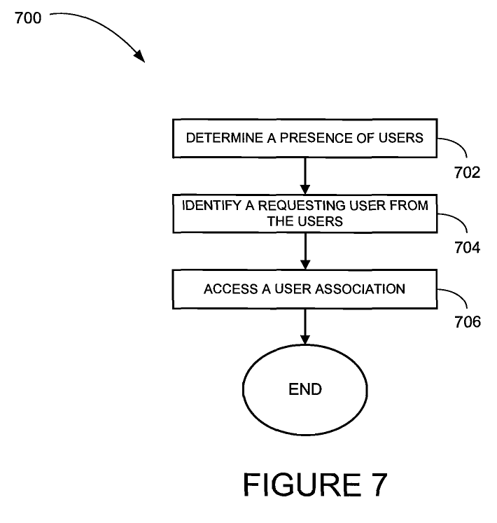

FIG. 7 illustrates a method 700 for determining a user association according to an example embodiment. The method 700 may be performed at block 502 (see FIG. 5) or otherwise performed.

An identity of multiple users is determined at block 702. For example, the multiple users may be in a region near a display device 106.1, 106.2.

At block 704, a requesting user is identified among the multiple users based on a selection criterion. The selection criterion may be the signal strength of a mobile device, a first user (e.g., of the display device 106.1, 106.2), a last user, a user most likely to select the content, or the like.

A user association of the requesting user with the electronic program guide is accessed at block 706. For example, the user association may be stored on a device with the electronic program guide to enable lookup of a particular electronic program guide from among multiple electronic program guides based on the user association. In an example embodiment, the electronic program guide may provided for the presentation based on the user association (e.g., as performed at block 506).

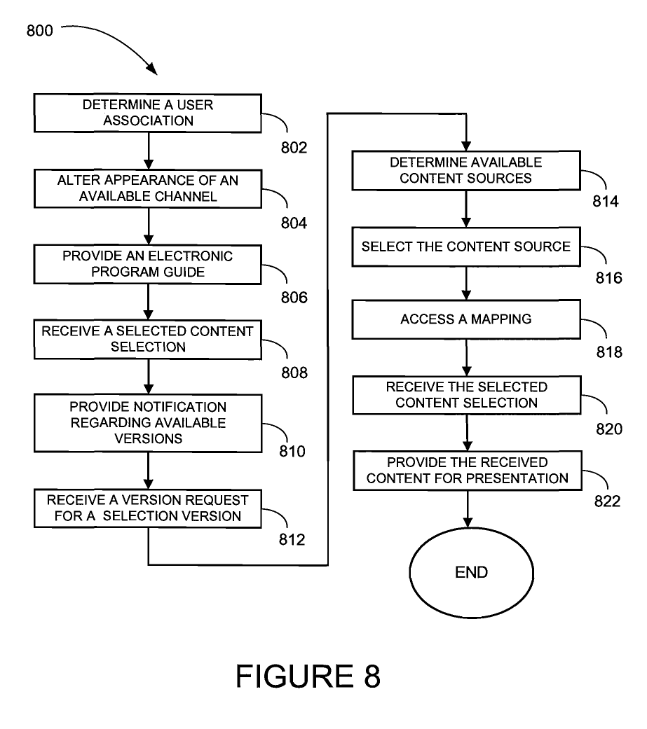

FIG. 8 illustrates a method 500 for content distribution according to an example embodiment. The method 500 may be performed by the guide subsystem 110 (see FIG. 1) of the content system 100 or otherwise performed.

At block 802, a user association may be determined to identify an electronic program guide associated with a particular user. For example, a login request may be received for the user and/or the identity of one or more users may be determined.

Appearance of an available channel of the available channels may be altered in accordance with a user profile at block 804. The alteration of the appearance may include channel highlighting or channel hiding. Other types of alterations may also be performed.

An electronic program guide is provided for presentation at block 806. The available channels of the electronic program guide may originate from a same source or different types of sources.

A selected content selection is received from the content selections at block 808. Notification regarding available versions of the content may be provided at block 810. The available versions may include director's version, an original version, an uncensored version, a censored version, an unrated version, or the like.

A request for a selected version of the content from the available versions may be received at block 812. Available content sources including the selected content selection may be determined at block 814.

The content source may be selected from the content sources based on a selection criterion. The selection criterion may be based on a content version, a start time of the selected content selection, an end time of the selected content selection, and/or the content source type of the selected content selection. The selection criterion may also be based on the easiest accessible content may be accessed (e.g., local, then broadcast, and then Internet), a desired content quality (e.g., highest quality), least expense content, a desired version of the content, and/or an ability to fast-forward the content.

A mapping associated with the selected content selection is accessed at block 818. The mapping may include a source identifier and a content identifier. The mapping may be accessed based on the selected content selection and the selection version.

At block 820, the selected content selection is received in accordance with the content identifier from the content source associated with the source identifier. At block 822, the received content is provided for presentation through a channel associated with the content selection.

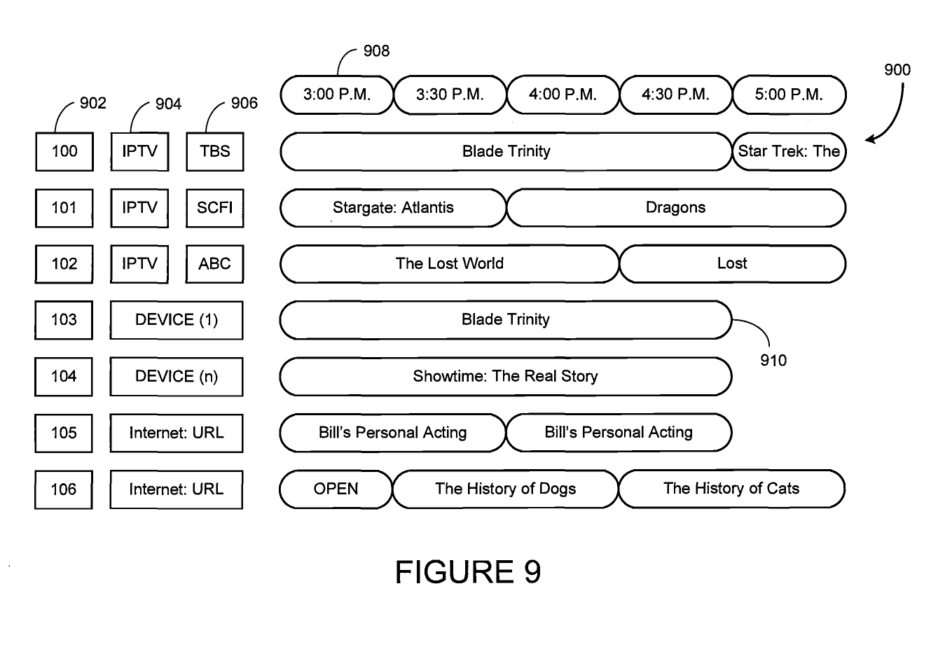

FIG. 9 illustrates an example electronic program guide 900 that may be provided in accordance with the method 300, method 400, method 500, and/or the method 800 (see FIGS. 3-5 and 8). However, other electronic program guides may also be provided.

The electronic program guide 900 is presented in a time-oriented manner with a unique value for a channel identifier 902 presented for a number of mapped channels. A source identifier 904 may indicate a source of the content. An source channel indication 906 is provided to indicate an original channel associated with a content source. A time indication 908 indicates a start time of a particular program 910.

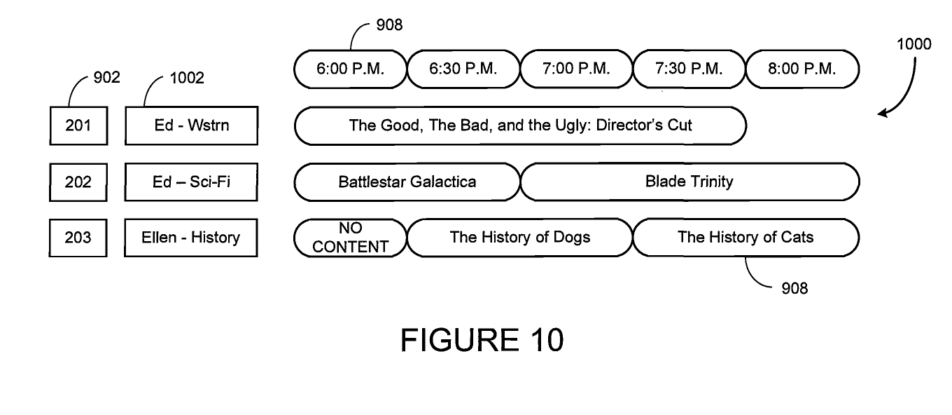

FIG. 10 illustrates an example electronic program guide 1000 that may be provided in accordance with the method 300, method 400, method 500, and/or the method 800 (see FIGS. 3-5 and 8).

The electronic program guide 1000 is presented in a time-oriented manner with a unique value for a channel identifier 1002 presented for a number of mapped channels. A mapped channel 1004 of the electronic program guide 1000 may be in accordance with a content profile. The content profile may enable selections from multiple content sources 102, 112 to appear under a single mapped channel 1004.

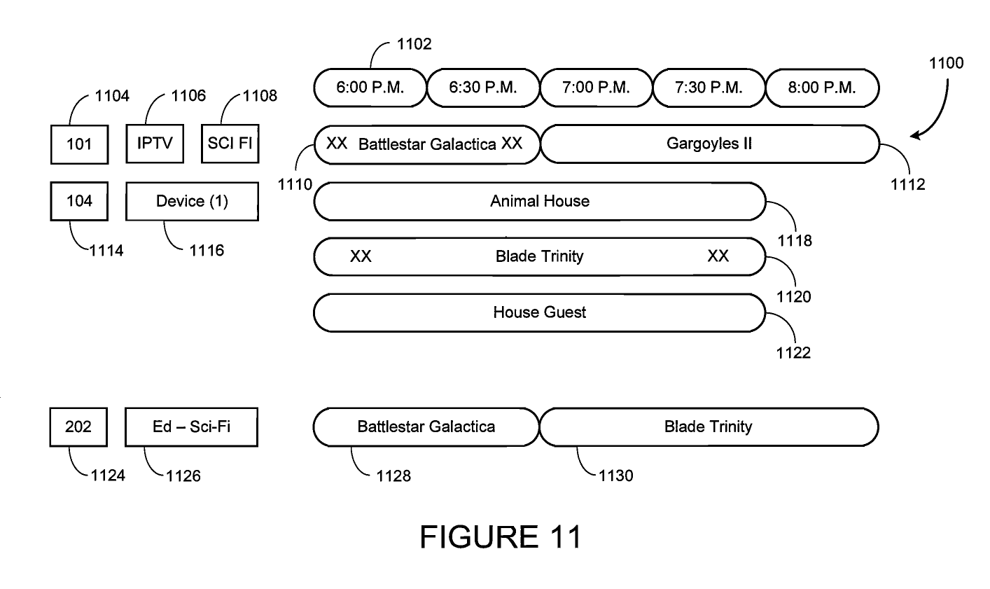

FIG. 11 illustrates an example electronic program guide 1100 that may be provided in accordance with the method 300, method 400, method 500, and/or the method 800 (see FIGS. 3-5 and 8).

The electronic program guide 1100 is presented to illustrate the mapping of a mapped channel of the electronic program guide 1000 (see FIG. 10).

Programs 1110, 1112, 1118, 1120, 1122, and shown as being available under the time indications 1102 for the channel identifiers 1104, 1114. The programs 1110, 1112 are available from a source identifier 1106 and a source channel indication 1108, while the programs 1118, 1120, 1122 are available from a source identifier 1116.

A channel identifier 1124 may be associated with a mapped channel 1126 in accordance with a user profile. A program 1128 may be selected from the program 1110, and a program 1130 may be selected from the program 1120 in accordance with the user profile.

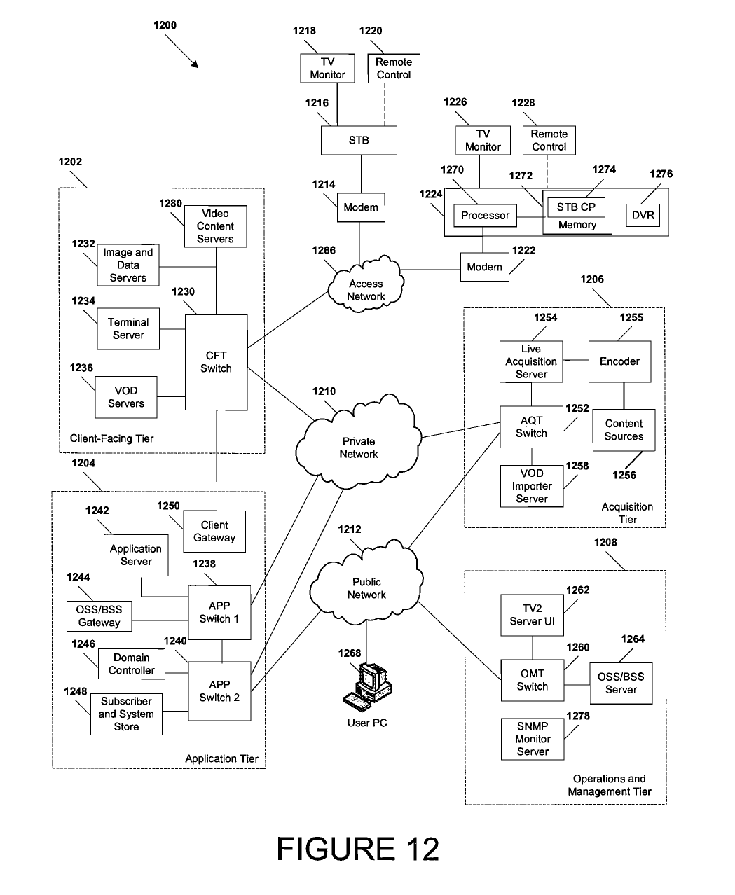

FIG. 12 illustrates an example embodiment of an Internet Protocol Television (IPTV) system 1200 in which the content system 100 may be deployed. However, the content system 100 may be deployed in other types of IPTV and non-IPTV video systems.

The system 1200 as illustrated may include a client facing tier 1202, an application tier 1204, an acquisition tier 1206, and an operations and management tier 1208. Some tiers 1202, 1204, 1206, 1208 may be coupled to a private network 1210; to a public network 1212, such as the Internet; or to both the private network 1210 and the public network 1212. For example, the client-facing tier 1202 may be coupled to the private network 1210. Further, the application tier 1204 may be coupled to the private network 1210 and to the public network 1212. The acquisition tier 1206 may also be coupled to the private network 1210 and to the public network 1212. Additionally, the operations and management tier 1208 may be coupled to the public network 1212.

As illustrated in FIG. 12, some of the various tiers 1202, 1204, 1206, 1208 may communicate with each other via the private network 1210 and the public network 1212. For instance, the client-facing tier 1202 may communicate with the application tier 1204 and the acquisition tier 1206 via the private network 1210. The application tier 1204 may also communicate with the acquisition tier 1206 via the private network 1210. Further, the application tier 1204 may communicate with the acquisition tier 1206 and the operations and management tier 1208 via the public network 1212. Moreover, the acquisition tier 1206 may communicate with the operations and management tier 1208 via the public network 1212. In a particular As illustrated in FIG. 12, the client-facing tier 1202 may communicate with user equipment via a private access network 1266 (e.g., the provider network 104 of FIG. 1), such as an IPTV access network. In an illustrative embodiment, modems, such as a first modem 1214 and a second modem 1222 may be coupled to the private access network 1266. The client-facing tier 1202 may communicate with a first representative set-top box device 1216 via the first modem 1214 and with a second representative set-top box device 1224 via the second modem 1222. The client-facing tier 1202 may communicate with a large number of set-top boxes, such as the representative set-top boxes 1216, 1224, (e.g., the receiver device 108 of FIG. 1) over a wide geographic area, such as a regional area, a metropolitan area, a viewing area, a designated market area or any other suitable geographic area, market area, or subscriber or customer group that may be supported by networking the client-facing tier 1202 to numerous set-top box devices. In an illustrative embodiment, the client-facing tier, or any portion thereof, may be included at a video head-end office.

In a particular embodiment, the client-facing tier 1202 may be coupled to the modems 1214, 1222 via fiber optic cables. Alternatively, the modems 1214 and 1222 may be digital subscriber line (DSL) modems that are coupled to one or more network nodes via twisted pairs, and the client-facing tier 1202 may be coupled to the network nodes via fiber-optic cables. Each set-top box device 1216, 1224 may process data received via the private access network 1266, via an IPTV software platform, such as Microsoft® TV IPTV Edition. In another embodiment, representative set-top boxes 1216, 1224 may receive data from private access network 1266 through RF and other cable and/or satellite based networks.

Additionally, the first set-top box device 1216 may be coupled to a first external display device, such as a first television monitor 1218, and the second set-top box device 1224 may be coupled to a second external display device, such as a second television monitor 1226. Moreover, the first set-top box device 1216 may communicate with a first remote control 1220, and the second set-top box device may communicate with a second remote control 1228.

In an example, non-limiting embodiment, one or more of set-top box devices 1216, 1224 may receive video content, which may include video and audio portions, from the client-facing tier 1202 via the private access network 1266. The set-top boxes 1216, 1224 may transmit the video content to an external display device, such as the television monitors 1218, 1226. Further, some of the set-top box devices 1216, 1224 may include a STB processor, such as STB processor 1270, and a STB memory device, such as STB memory 1272, which is accessible to the STB processor 1270. In one embodiment, a computer program, such as the STB computer program 1274, may be embedded within the STB memory device 1272. Some set-top box devices 1216, 1224 may also include a video content storage module, such as a digital video recorder (DVR) 1276. In a particular embodiment, the set-top box devices 1216, 1224 may communicate commands received from the remote control devices 1220, 1228 to the client-facing tier 1202 via the private access network 1266.

In an illustrative embodiment, the client-facing tier 1202 may include a client-facing tier (CFT) switch 1230 that manages communication between the client-facing tier 1202 and the private access network 1266 and between the client-facing tier 1202 and the private network 1210. As shown, the CFT switch 1230 is coupled to one or more image and data servers 1232 that store still images associated with programs of various IPTV channels. The image and data servers 1232 may also store data related to various channels, e.g., types of data related to the channels and to programs or video content displayed via the channels. In an illustrative embodiment, the image and data servers 1232 may be a cluster of servers, some of which may store still images, channel and program-related data, or any combination thereof. The CFT switch 1230 may also be coupled to a terminal server 1234 that provides terminal devices with a connection point to the private network 1210. In a particular embodiment, the CFT switch 1230 may also be coupled to one or more video-on-demand (VOD) servers 1236 that store or provide VOD content imported by the IPTV system 1200. In an illustrative, non-limiting embodiment, the VOD content servers 1280 may include one or more unicast servers.

The client-facing tier 1202 may also include one or more video content servers 1280 that transmit video content requested by viewers via their set-top boxes 1216, 1224. In an illustrative, non-limiting embodiment, the video content servers 1280 may include one or more multicast servers.

As illustrated in FIG. 12, the application tier 1204 may communicate with both the private network 1210 and the public network 1212. The application tier 1204 may include a first application tier (APP) switch 1238 and a second APP switch 1240. In a particular embodiment, the first APP switch 1238 may be coupled to the second APP switch 1240. The first APP switch 1238 may be coupled to an application server 1242 and to an OSS/BSS gateway 1244. In a particular embodiment, the application server 1242 may provide applications to the set-top box devices 1216, 1224 via the private access network 1266, which enable the set-top box devices 1216, 1224 to provide functions, such as display, messaging, processing of IPTV data and VOD material, etc. In a particular embodiment, the OSS/BSS gateway 1244 includes operation systems and support (OSS) data, as well as billing systems and support (BSS) data. In one embodiment, the OSS/BSS gateway may provide or restrict access to an OSS/BSS server 1264 that stores operations and billing systems data.

Further, the second APP switch 1240 may be coupled to a domain controller 1246 that provides web access, for example, to users via the public network 1212. For example, the domain controller 1246 may provide remote web access to IPTV account information via the public network 1212, which users may access using their personal computers 1268. The second APP switch 1240 may be coupled to a subscriber and system store 1248 that includes account information, such as account information that is associated with users who access the system 1200 via the private network 1210 or the public network 1212. In a particular embodiment, the application tier 1204 may also include a client gateway 1250 that communicates data directly with the client-facing tier 1202. In this embodiment, the client gateway 1250 may be coupled directly to the CFT switch 1230. The client gateway 1250 may provide user access to the private network 1210 and the tiers coupled thereto.

In a particular embodiment, the set-top box devices 1216, 1224 may access the IPTV system 1200 via the private access network 1266, using information received from the client gateway 1250. In this embodiment, the private access network 1266 may provide security for the private network 1210. User devices may access the client gateway 1250 via the private access network 1266, and the client gateway 1250 may allow such devices to access the private network 1210 once the devices are authenticated or verified. Similarly, the client gateway 1250 may prevent unauthorized devices, such as hacker computers or stolen set-top box devices from accessing the private network 1210, by denying access to these devices beyond the private access network 1266.

For example, when the first representative set-top box device 1216 accesses the system 1200 via the private access network 1266, the client gateway 1250 may verify subscriber information by communicating with the subscriber and system store 1248 via the private network 1210, the first APP switch 1238, and the second APP switch 1240. Further, the client gateway 1250 may verify billing information and status by communicating with the OSS/BSS gateway 1244 via the private network 1210 and the first APP switch 1238. In one embodiment, the OSS/BSS gateway 1244 may transmit a query across the first APP switch 1238, to the second APP switch 1240, and the second APP switch 1240 may communicate the query across the public network 1212 to the OSS/BSS server 1264. After the client gateway 1250 confirms subscriber and/or billing information, the client gateway 1250 may allow the set-top box device 1216 access to IPTV content and VOD content. If the client gateway 1250 is unable to verify subscriber information for the set-top box device 1216, e.g., because it is connected to an unauthorized twisted pair, the client gateway 1250 may block transmissions to and from the set-top box device 1216 beyond the private access network 1266.

As indicated in FIG. 12, the acquisition tier 1206 includes an acquisition tier (AQT) switch 1252 that communicates with the private network 1210. The AQT switch 1252 may also communicate with the operations and management tier 1208 via the public network 1212. In a particular embodiment, the AQT switch 1252 may be coupled to a live acquisition server 1254 that receives television or movie content, for example, from content sources 1256 through an encoder 1255. In a particular embodiment during operation of the IPTV system, the live acquisition server 1254 may acquire television or movie content. The live acquisition server 1254 may transmit the television or movie content to the AQT switch 1252 and the AQT switch 1252 may transmit the television or movie content to the CFT switch 1230 via the private network 1210.

Further, the television or movie content may be transmitted to the video content servers 1280, where it may be encoded, formatted, stored, or otherwise manipulated and prepared for communication to the set-top box devices 1216, 1224. The CFT switch 1230 may communicate the television or movie content to the modems 1214, 1222 via the private access network 1266. The set-top box devices 1216, 1224 may receive the television or movie content via the modems 1214, 1222, and may transmit the television or movie content to the television monitors 1218, 1226. In an illustrative embodiment, video or audio portions of the television or movie content may be streamed to the set-top box devices 1216, 1224.

Further, the AQT switch may be coupled to a video-on-demand importer server 1258 that stores television or movie content received at the acquisition tier 1206 and communicates the stored content to the VOD server 1236 at the client-facing tier 1202 via the private network 1210. Additionally, at the acquisition tier 1206, the VOD importer server 1258 may receive content from one or more VOD sources outside the IPTV system 1200, such as movie studios and programmers of non-live content. The VOD importer server 1258 may transmit the VOD content to the AQT switch 1252, and the AQT switch 1252, in turn, may communicate the material to the CFT switch 1230 via the private network 1210. The VOD content may be stored at one or more servers, such as the VOD server 1236.

When a user issues requests for VOD content via the set-top box devices 1216, 1224, the requests may be transmitted over the private access network 1266 to the VOD server 1236, via the CFT switch 1230. Upon receiving such requests, the VOD server 1236 may retrieve the requested VOD content and transmit the content to the set-top box devices 1216, 1224 across the private access network 1266, via the CFT switch 1230. The set-top box devices 1216, 1224 may transmit the VOD content to the television monitors 1218, 1226. In an illustrative embodiment, video or audio portions of VOD content may be streamed to the set-top box devices 1216, 1224.

FIG. 12 further illustrates that the operations and management tier 1208 may include an operations and management tier (OMT) switch 1260 that conducts communication between the operations and management tier 1208 and the public network 1212. In the embodiment illustrated by FIG. 12, the OMT switch 1260 is coupled to a TV2 server 1262. Additionally, the OMT switch 1260 may be coupled to an OSS/BSS server 1264 and to a simple network management protocol (SNMP) monitor 1278 that monitors network devices within or coupled to the IPTV system 1200. In a particular embodiment, the OMT switch 1260 may communicate with the AQT switch 1252 via the public network 1212.

In an illustrative embodiment, the live acquisition server 1254 may transmit the television or movie content to the AQT switch 1252, and the AQT switch 1252, in turn, may transmit the television or movie content to the OMT switch 1260 via the public network 1212. In this embodiment, the OMT switch 1260 may transmit the television or movie content to the TV2 server 1262 for display to users accessing the user interface at the TV2 server 1262. For example, a user may access the TV2 server 1262 using a personal computer (PC) 1268 coupled to the public network 1212.

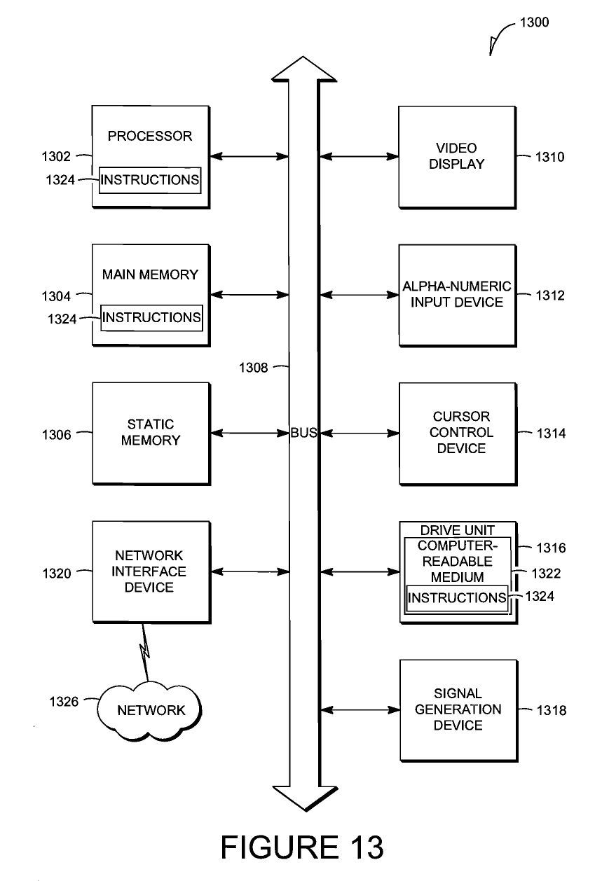

FIG. 13 shows a diagrammatic representation of machine in the example form of a computer system 1300 within which a set of instructions may be executed causing the machine to perform any one or more of the methods, processes, operations, or methodologies discussed herein. The local content sources 112, the remote content sources 102, the local guide provider 114, and/or the remote guide providers 116 may be deployed on the computer system 1300. The display device 106.1, 106.2, and/or the receiver device 108 may include the functionality of the computer system 1300.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a STB, a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU) a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a cursor control device 1314 (e.g., a mouse), a drive unit 1316, a signal generation device 1318 (e.g., a speaker) and a network interface device 1320.

The drive unit 1316 includes a machine-readable medium 1322 on which is stored one or more sets of instructions (e.g., software 1324) embodying any one or more of the methodologies or functions described herein. The software 1324 may also reside, completely or at least partially, within the main memory 1304 and/or within the processor 1302 during execution thereof by the computer system 1300, the main memory 1304 and the processor 1302 also constituting machine-readable media.

The software 1324 may further be transmitted or received over a network 1326 via the network interface device 1320.

While the machine-readable medium 1322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies shown in the various embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for content mapping have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving information regarding available content from a plurality of content sources;
providing a plurality of available content selections for presentation, the plurality of available content selections in accordance with the received information;
receiving a selection of content from a user, the selection from the plurality of available content selections, the content associated with a selected content source from the plurality of content sources, the content source being of a source type;
mapping a channel to the content in accordance with the source type to create a mapped channel; and
adding the mapped channel to an electronic program guide.

2. The method of claim 1, wherein the receiving of the selection of the content further comprises:
identifying the source type of the selected content source associated with the selection; and
identifying an access identifier for the selected content source;
wherein the mapping of the channel to the selection of the content is in accordance with the source type and the access identifier to create the mapped channel.

3. The method of claim 2, wherein the access identifier includes at least one of an IP address, an IPTV server address, a frequency, a URL, or combinations thereof.

4. The method of claim 1, further comprising:
providing the electronic program guide for presentation to the user.

5. The method of claim 1, wherein the information regarding the available content includes scheduling data, a content guide, a content listing, or combinations thereof.

6. A machine-readable medium comprising instructions, which when implemented by one or more processors perform the following operations:
receive information regarding available content from a plurality of content sources;
process a selection of content from the plurality of available content selections in accordance with a profile, the content associated with a selected content source from the plurality of content sources, the selected content source being of a source type;
mapping a channel to the content in accordance with the source type to create a mapped channel; and
adding the mapped channel to an electronic program guide.

7. The machine-readable medium of claim 6, wherein the profile is associated with at least one of a particular user, a particular content genre, a particular content source, or combinations thereof.

8. The machine-readable medium of claim 6, wherein the one or more instructions to process the selection of the content includes:
provide a content notification of the content according to the profile; and
receive a content request in response to the content notification;
wherein processing of the selection of the content from the plurality of available content selections is in accordance with the profile and the content request.

9. A method comprising:
providing an electronic program guide for presentation, the electronic program guide including a plurality of available channels;
receiving a channel selection of one of the available channels from the plurality of available channels;
accessing a mapping associated with the channel selection, the mapping including a source identifier and a content identifier;
receiving content in accordance with the content identifier from a content source associated with the source identifier; and
providing the received content for presentation through the available channel.

10. The method of claim 9, wherein the source identifier is a television broadcast station and the content identifier includes an original channel selection.

11. The method of claim 9, further comprising:
determining an identity of a user; and
accessing a user association of the user with the electronic program guide;
wherein the electronic program guide is provided for the presentation based on the user association.

12. The method of claim 11, wherein the identity of the user is determined by at least one of:
a mobile telephone associated with the user,
a portable gaming device associated with the user
a remote control associated with the user, or
combinations thereof.

13. The method of claim 9, further comprising:
determining an identity of a plurality of users;
identifying a requesting user from the plurality of users based on a selection criterion; and
accessing an association of the requesting user with the electronic program guide;
wherein the electronic program guide is provided for the presentation based on the association.

14. The method of claim 9, further comprising:
altering appearance of at least one available channel of the plurality of available channels in accordance with a user profile;
wherein the altered programming guide is provided for presentation.

15. A machine-readable medium comprising instructions, which when implemented by one or more processors perform the following operations:
provide an electronic program guide for presentation, the electronic program guide including a plurality of content selections;
receive a selected content selection from the plurality of content selections;
access a mapping associated with the selected content selection, the mapping including a source identifier and a content identifier;
receive the selected content selection in accordance with the content identifier from a content source associated with the source identifier; and
provide the received content for presentation through a channel associated with the content selection.

16. The machine-readable medium of claim 15 further comprising instructions, which when implemented by one or more processors perform the following operations:
determine a plurality of available content sources including the selected content selection; and
select the content source from the plurality of content sources based on a selection criterion.

17. The machine-readable medium of claim 16, wherein the selection criterion includes a content version, a start time of the selected content selection, an end time of the selected content selection, the content source type of the selected content selection, or combinations thereof.

18. The machine-readable medium of claim 15 further comprising instructions, which when implemented by one or more processors perform the following operations:
providing notification regarding a plurality of available versions of the content; and
receiving a request for a selected version of the content from the plurality of available versions;
wherein the mapping is accessed based on the selected content selection and the selection version.

19. A system comprising:
an information receiver module to receive information regarding available content from a plurality of content sources;
a selection provider module to provide a plurality of available content selections for presentation, the plurality of available content selections in accordance with the received information;
a selection receiver module to receive a selection of content from a user, the selection from the plurality of available content selections, the content associated with a selected content source from the plurality of content sources, the selected content source being of a source type;
a mapping creation module to map a channel to the selected content in accordance with the source type to create a mapped channel; and
a channel addition module to add the mapped channel to an electronic program guide.

20. The system of claim 19, further comprising:
a guide provider module to provide the electronic program guide for presentation;
a channel selection receiver module to receive a channel selection of one of the available channels from the plurality of available channels;
a mapping access module to access a mapping associated with the channel selection, the mapping including a source identifier and a content identifier;
a content receiver module to receive content in accordance with the content identifier from a content source associated with the source identifier; and
a content provider module to provide the received content for presentation through the available channel.

21. The system of claim 19, further comprising:
a guide provide module to provide an electronic program guide for presentation, the electronic program guide including a plurality of content selections;
the selection receiver module to receiving a selected content selection from the plurality of content selections;
a mapping access module to access a mapping associated with the selected content selection, the mapping including a source identifier and a content identifier;
a content source selection module to receive the selected content selection in accordance with the content identifier from a content source associated with the source identifier; and
a content provider module to provide the received content for presentation through a channel associated with the content selection.
